(19) United States
(12) Patent Application Publication
(10) Pub. No.: US 2018/0050298 A1
(43) Pub. Date: Feb. 22, 2018

(54) WATER COLLECTION DEVICE AND WATER COLLECTION METHOD

(71) Applicants: SHARP KABUSHIKI KAISHA, Sakai City, Osaka (JP); THE SCHOOL CORPORATION KANSAI UNIVERSITY, Suita-shi (JP)

(72) Inventors: NOBUKI SAKIKAWA, Sakai City (JP); YOSHIHIRO URAMOTO, Sakai City (JP); TAKASHI MIYATA, Suita-shi (JP)

(21) Appl. No.: 15/552,479

(22) PCT Filed: Feb. 17, 2016
(86) PCT No.: PCT/JP2016/054622

§ 371 Date: Aug. 21, 2017

(30) Foreign Application Priority Data
Apr. 8, 2015 (JP) 2015-079619

(51) Int. Cl. B01D 53/26; B01J 20/26; B01J 20/28; B01J 20/34; B01D 53/28

(52) U.S. Cl. CPC B01D 53/261; B01J 20/26; B01D 53/28; B01J 20/3441; B01J 20/3483; B01J 20/28

(57) ABSTRACT

An object of the present invention is to provide a water collecting device and a water collecting method each of which makes it possible to efficiently extract water absorbed as moisture in a polymeric moisture-absorbing material. The object is achieved by a water collecting device including: a stimulus applying section for applying an external stimulus which is intended to decrease the affinity with water of a polymeric moisture-absorbing material; and a vibration section for providing vibration to the polymeric moisture-absorbing material having a decreased affinity with water and thereby causing water to be released from the polymeric moisture-absorbing material.

### TECHNICAL FIELD

The present invention relates to a water collecting device and a water collecting method.

### BACKGROUND ART

Dehumidifying devices and humidity control devices are typified by two types: a refrigeration cycle system and a zeolite system. The refrigeration cycle system includes a compressor, and is a system in which indoor air is dehumidified by causing moisture in air to condense through cooling of the indoor air with the use of an evaporator (see, for example, Patent Literature 1). The zeolite system uses a rotor obtained by processing a moisture absorbing porous material such as zeolite into the form of a rotor. Specifically, in the zeolite system, (i) the rotor is made to absorb moisture in indoor air, (ii) the rotor, which has thus absorbed the moisture, is exposed to hot air generated by an electric heater, so that the moisture in the rotor is extracted as high-temperature, high-humidity air, and (iii) the high-temperature, high-humidity air is cooled with use of indoor air, so that the moisture in the high-temperature, high-humidity air is condensed and the indoor air is dehumidified (see, for example, Patent Literatures 2 and 3). Furthermore, a system, in which the respective characteristics of a refrigeration cycle system and a zeolite system are combined, is also used (see, for example, Patent Literature 4). Furthermore, a so-called desiccant air conditioning system, in which air conditioning such as a cooling operation is carried out by causing an adsorbent (for example, silica gel, activated carbon, or zeolite) to adsorb and desorb moisture, has become prevalent as a large-scale air conditioning system. Demands for protection of global environment have caused current active development of highly efficient humidity control systems (see, for example, Patent Literatures 5 and 6).

However, the refrigeration cycle system still poses problems such as (i) the use of a halogen-based gas which leads to environmental destruction, (ii) the tendency to cause a dehumidifying device or a humidity control device to be large in size for installation of a compressor, and (iii) loud noise. Meanwhile, the zeolite system requires heat of not less than 200° C. for regeneration, and is therefore inefficient. A hybrid type, which is obtained by combining the refrigeration cycle system and the zeolite system, has made an improvement such as use of part of compression heat of a compressor for regeneration of a zeolite rotor. This allows the zeolite system to be used for a wider range of purposes. However, a complex air pathway and a complex mechanism are necessary, and it is therefore impossible to avoid causing a dehumidifying device or a humidity control device to be large in size. Furthermore, the fact that water vapor, which has been collected by adsorption or the like, is condensed by supersaturation cooling has not been changed. Furthermore, even a desiccant air conditioning system requires a large heat quantity for adsorbing and desorbing moisture.

Meanwhile, a dehumidifying/water-absorbing sheet containing a temperature-sensitive polymer gel has been proposed as a method for removing dew drops, though such a technique is not related to either a dehumidifying device or a humidity control device (see, for example, Patent Literature 7).

### Citation List

### Patent Literatures

[Patent Literature 1]

Japanese Patent Application Publication Tokukai No. 2002-310485 (Publication date: Oct. 23, 2002)

[Patent Literature 2]

Japanese Patent Application Publication Tokukai No. 2001-259349 (Publication date: Sep. 25, 2001)

[Patent Literature 3]

Japanese Patent Application Publication Tokukai No. 2003-144833 (Publication date: May 20, 2003)

[Patent Literature 4]

Japanese Patent Application Publication Tokukai No. 2005-34838 (Publication date: Feb. 10, 2005)

[Patent Literature 5]

Japanese Patent Application Publication Tokukaihei No. 5-301014 (Publication date: Nov. 16, 1993)

[Patent Literature 6]

Japanese Patent Application Publication Tokukai No. 2010-54184 (Publication date: Mar. 11, 2010)

[Patent Literature 7]

Japanese Patent Application Publication Tokukai No. 2002-126442 (Publication date: May 8, 2002)

### SUMMARY OF INVENTION

### Technical Problem

The dehumidifying/water-absorbing sheet containing a temperature-sensitive polymer gel, however, is relevant to a technique for absorbing water in the form of droplets. Further, the efficiency of extraction of the water absorbed in the dehumidifying/water-absorbing sheet has not been sufficient.

In a case where a stimuli-responsive polymer is used as a humidity control material, it is more difficult to extract water from a moisture absorbing material which has absorbed water in air.

Embodiments of the present invention are attained in view of the above problems. An object of embodiments of the present invention is to provide a water collecting device and a water collecting method each of which makes it possible to efficiently collect, from a polymeric moisture-absorbing material, water that has been absorbed as moisture in the polymeric moisture-absorbing material containing a stimuli-responsive polymer.

### Solution to Problem

In order to solve the above-problems, a water collecting device in accordance with an embodiment of the present invention includes: a polymeric moisture-absorbing material containing a stimuli-responsive polymer whose affinity with water changes reversibly in response to an external stimulus; a stimulus applying section for applying an external stimulus so as to decrease the affinity with water of the polymeric moisture-absorbing material; and a vibration section for providing vibration to the polymeric moisture-absorbing material having a decreased affinity with water so as to collect water released from the polymeric moisture-absorbing material.

In order to solve the above-problems, a water collecting method in accordance with an embodiment of the present invention includes the steps of: decreasing affinity with water of a polymeric moisture-absorbing material, by applying an external stimulus to the polymeric moisture absorbing material having absorbed moisture in air, the polymeric moisture-absorbing material containing a stimuli-responsive polymer whose affinity with water changes reversibly in response to the external stimulus; and providing vibration to the polymeric moisture-absorbing material having a decreased affinity with water so as to collect water released from the polymeric moisture-absorbing material.

### Advantageous Effects of Invention

The above configuration makes it possible to provide a water collecting device and a water collecting method each of which makes it possible to efficiently collect, from a polymeric moisture-absorbing material, water that has been absorbed as moisture by the polymeric moisture-absorbing material containing a stimuli-responsive polymer.

### BRIEF DESCRIPTION OF DRAWINGS

FIG. 1 shows diagrams conceptually illustrating how water (water vapor) in air is absorbed and released in accordance with embodiments of the present invention each of which embodiments uses a porous, polymeric moisture absorbing material.

FIG. 2 is a longitudinal cross-sectional view of a water collecting device in accordance with Embodiment 1 of the present invention.

FIG. 3 is a transverse cross-sectional view of the water collecting device in accordance with Embodiment 1 of the present invention.

FIG. 4 is a diagram illustrating an element in a state where (i) the element has moved into a release region as a result of rotation of a moisture absorbing unit and (ii) an ultrasonic vibrator has not yet come into contact with a heater of the element, in Embodiment 1 of the present invention.

FIG. 5 is a diagram illustrating an element in a state where (i) the element has moved into the release region as a result of rotation of the moisture absorbing unit and (ii) the ultrasonic vibrator has come into contact with a heater of the element, in Embodiment 1 of the present invention.

FIG. 6 is a longitudinal cross-sectional view of a water collecting device in accordance with Embodiment 2 of the present invention.

FIG. 7 is a transverse cross-sectional view of the water collecting device in accordance with Embodiment 2 of the present invention.

FIG. 8 is a diagram illustrating an element in a state where (i) the element has moved into a release region as a result of rotation of a moisture absorbing unit and (ii) an ultrasonic vibrator has not yet come into contact with a heater of the element, in Embodiment 2 of the present invention.

FIG. 9 is a diagram illustrating an element in a state where (i) the element has moved into the release region as a result of rotation of the moisture absorbing unit and (ii) the ultrasonic vibrator has come into contact with a heater of the element, in Embodiment 2 of the present invention.

FIG. 10 is a longitudinal cross-sectional view of a water collecting device in accordance with Embodiment 3 of the present invention.

FIG. 11 is a transverse cross-sectional view of the water collecting device in accordance with Embodiment 3 of the present invention.

FIG. 12 is a diagram illustrating an element in a state where (i) the element has moved into a release region as a result of rotation of a main moisture absorbing unit and (ii) a main ultrasonic vibrator has not yet come into contact with a main heater of the element, in Embodiment 3 of the present invention.

FIG. 13 is a diagram illustrating an element in a state where (i) the element has moved into the release region as a result of rotation of the main moisture absorbing unit and (ii) the main ultrasonic vibrator has come into contact with a main heater of the element, in Embodiment 3 of the present invention.

FIG. 14 is a diagram illustrating a state in which water having been extracted to appear on a surface of the main polymeric moisture-absorbing material is transferred to a secondary polymeric moisture-absorbing material, in Embodiment 3 of the present invention.

FIG. 15 is a diagram illustrating a state in which a contact between a secondary ultrasonic vibrator and a secondary heater causes released water to be extracted to appear on a surface of the secondary polymeric moisture-absorbing material, in Embodiment 3 of the present invention.

FIG. 16 is a longitudinal cross-sectional view of a water collecting device in accordance with Embodiment 4 of the present invention.

FIG. 17 is a transverse cross-sectional view of the water collecting device in accordance with Embodiment 4 of the present invention.

FIG. 18 is a diagram illustrating an element in a state where (i) the element has moved into a release region as a result of rotation of a main moisture absorbing unit and (ii) a main ultrasonic vibrator has not yet come into contact with a main heater of the element, in Embodiment 4 of the present invention.

FIG. 19 is a diagram illustrating an element in a state where (i) the element has moved into the release region as a result of rotation of the main moisture absorbing unit and (ii) the main ultrasonic vibrator has come into contact with a main heater of the element, in Embodiment 4 of the present invention.

FIG. 20 is a diagram illustrating a state in which a contact between a secondary ultrasonic vibrator and a secondary heater causes water released from a water collecting element of a secondary moisture absorbing unit to be extracted to appear on a surface of the secondary polymeric moisture-absorbing material, in Embodiment 4 of the present invention.

FIG. 21 is a longitudinal cross-sectional view of a water collecting device in accordance with Embodiment 5 of the present invention.

FIG. 22 is a transverse cross-sectional view of the water collecting device in accordance with Embodiment 5 of the present invention.

FIG. 23 is a diagram illustrating a state in which water accumulated in an adsorbing material of an adsorbing roller is collected by applying pressure to the adsorbing material with use of a compression roller, in Embodiment 5 of the present invention.

FIG. 24 is a diagram illustrating an element in a state where (i) the element has moved into a release region as a result of rotation of a moisture absorbing unit and (ii) an ultrasonic vibrator has come into contact with a heater of the element, in Embodiment 5 of the present invention.

### DESCRIPTION OF EMBODIMENTS

### Embodiment 1

The following description will discuss an embodiment of the present invention.

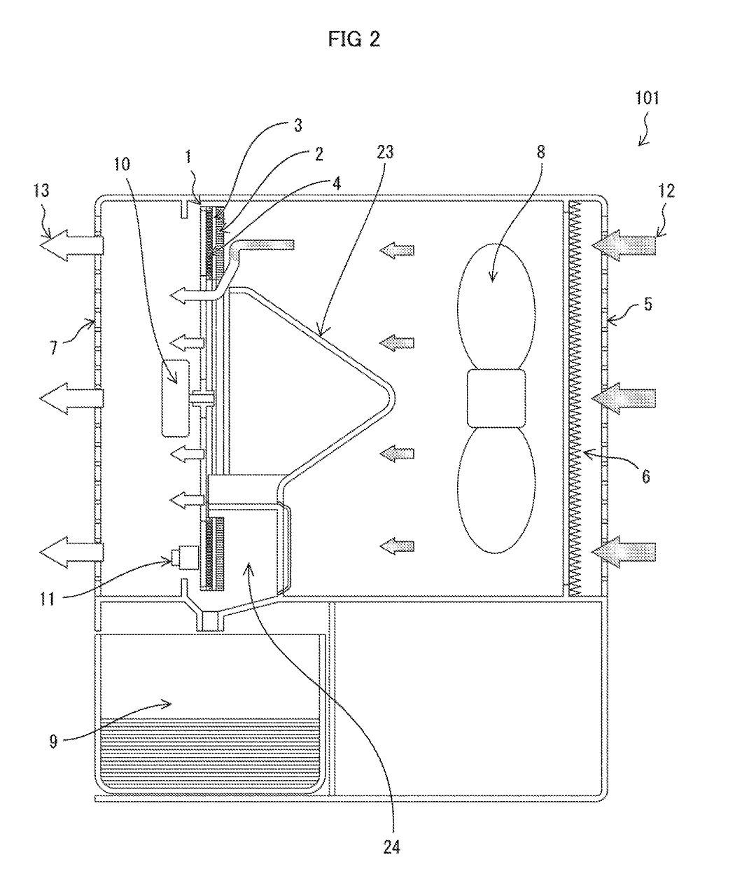

FIG. 2 is a longitudinal cross-sectional view of a water collecting device 101 in accordance with Embodiment 1 of the present invention.

The water collecting device 101 includes a housing in the shape of a rectangular parallelepiped. The housing has (i) an air inlet 5 in a side surface of an upper portion thereof, (ii) an air outlet 7 in a side surface of the upper portion which side surface is opposite to the above side surface, and (iii) a tank containing section positioned at a lower portion of the housing on the side of the air outlet 7 and configured to contain a water drain tank 9. The water collecting device 101 contains an inlet air filter 6 adjacent to the air inlet 5.

The water collecting device 101 further contains an airflow restriction wall 23 between the air inlet 5 and the air outlet 7. Air that has been taken in through the air inlet 5 flows through a space restricted by the airflow restriction wall 23 (see the arrows in FIG. 2). Air flows along a path on which are provided the air inlet 5, the inlet air filter 6, an air blowing fan 8, a moisture absorbing unit 1, and the air outlet 7 in this order from the side of the entry of air.

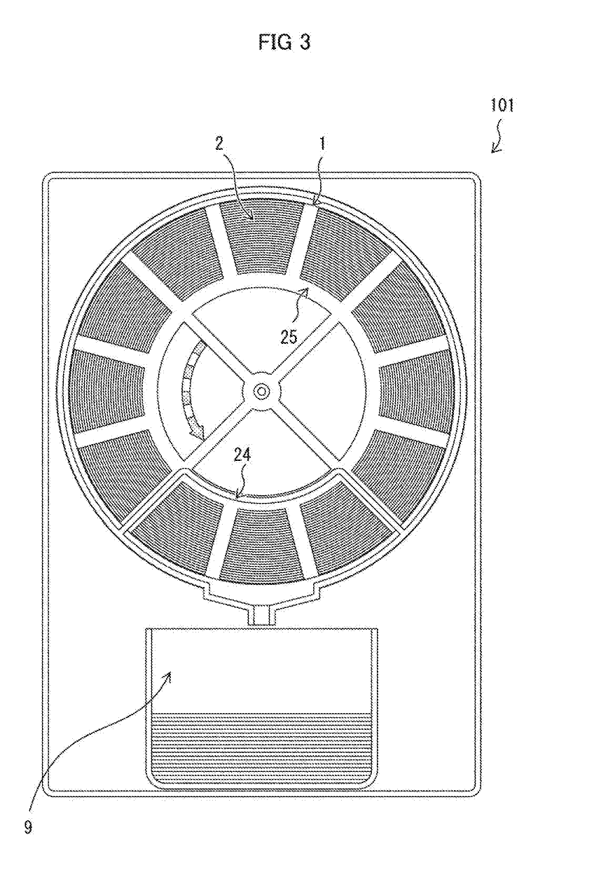

The moisture absorbing unit 1 is a member in which a plurality of elements each provided with a plate-shaped heater 4 are fixed in a radial arrangement to a disk-like base that rotates. The plate-shaped heater 4 is provided on a side of a base material 3 of a stack, which includes the base material 3 and a polymeric moisture absorbing material 2 disposed on the base material 3, so as to be in contact with the base material 3. The base material 3 has a rectangular plate shape. FIG. 3 is a transverse cross-sectional view of the water collecting device 101 along a cross section including layers of the polymeric moisture-absorbing material 2. As illustrated in FIGS. 2 and 3, the moisture absorbing unit 1 is on a plane parallel to that side surface of the housing of the water collecting device 101 in which the air inlet 5 is present and to that side surface of the housing of the water collecting device 101 in which the air outlet 7 is present. The moisture absorbing unit 1 includes a plurality of elements, each of which includes a polymeric moisture absorbing material 2, a base material 3, and a heater 4 arranged in this order from the side of the air inlet 5 to the side of the air outlet 7. The individual elements of the moisture absorbing unit 1 are arranged at even intervals radially on the circumference of a circle having a center at the rotary shaft of a stepping motor 10. The elements are rotatable around the rotary shaft in the direction indicated with the arrow in FIG. 3 (counterclockwise). The moisture absorbing unit 1 is driven by the stepping motor 10, which is controlled by a control section (not shown in the drawings), and is configured to be rotated at predetermined time intervals and at a predetermined angle of rotation.

The polymeric moisture-absorbing material 2 contains a stimuli-responsive polymer. The stimuli-responsive polymer of Embodiment 1 is a temperature-responsive polymer, whose affinity with water changes reversibly in response to heat. The temperature-responsive polymer is a polymer having a lower critical solution temperature (hereinafter referred to also as “LCST”). A polymer having an LCST is hydrophilic at low temperatures and becomes hydrophobic at an LCST or higher. Note that “LCST” herein refers to a temperature that serves as a boundary for a case where a polymer is dissolved below which boundary the polymer is hydrophilic so as to be dissolved in water and at or above which boundary the polymer is hydrophobic so as to be insoluble in water.

The stimuli-responsive polymer is preferably a porous material, but is not necessarily a porous material. Specific examples of the polymeric moisture absorbing material 2 will be described later.

As illustrated in FIG. 3, the moisture absorbing unit 1 is rotated in a region divided into (i) a moisture absorption region 25, which is positioned in an upper portion of the water collecting device 101, and (ii) a release region 24, which is positioned in a lower portion of the water collecting device 101. Each time the moisture absorbing unit 1 is rotated at the predetermined time interval and by the predetermined angle of rotation, one of the individual elements moves from the moisture absorption region 25 into the release region 24, and another one of the individual elements moves from the release region 24 into the moisture absorption region 25. Embodiment 1 is configured such that three elements positioned in a lower portion of the water collecting device 101 are in the release region 24. The water collecting device 101 includes in the release region 24 (i) a heater-specific fixed electrode (not shown in the drawings) positioned so as to, for conduction of electricity to the heater 4 of the element that has last entered the release region 24, come into contact with a heater electrode of that heater 4 and (ii) another heater-specific fixed electrode (not shown in the drawings) positioned so as to, for conduction of electricity to the heater 4 of the element that is next to the above element and that is positioned at the lowermost position in the water collecting device 101, come into contact with a heater electrode of that heater 4. With this configuration, when the individual elements of the moisture absorbing unit 1 are each driven by the stepping motor 10 to rotate to reach the position of either heater-specific fixed electrode, the heater 4 of the element is supplied with electricity and turned on. Embodiment 1 is configured such that the heater 4 of the element that is to move next out of the release region 24 into the moisture absorption region 25 is not turned on and that the polymeric moisture absorbing material 2 of that element having been heated is naturally cooled.

Further, the water collecting device 101 includes an ultrasonic vibrator 11 in the release region 24. The ultrasonic vibrator 11 is positioned such that when one of the individual elements reaches the lowermost position in the water collecting device 101 as a result of rotation of the moisture absorbing unit 1, the ultrasonic vibrator 11 is close to the heater 4 of the element. Then, when one of the individual elements reaches the lowermost position in the water collecting device 101 as a result of rotation of the moisture absorbing unit 1, the ultrasonic vibrator 11 is controlled by a control section (not shown in the drawings) so as to come in contact with the heater 4 at a predetermined time point and then to transmit ultrasonic vibration to the heater 4. The ultrasonic vibrator 11 provides ultrasonic vibration to each polymeric moisture-absorbing material 2 via the heater 4 and the base material 3 of the element.

With the airflow restriction wall 23, air that has been taken in through the air inlet 5 passes through only the moisture absorption region 25 and is prevented from flowing through the release region 24. At the bottom of the release region 24, the water collecting device 101 has a drip opening, which allows collected water to be discharged into the water drain tank 9 under the drip opening.

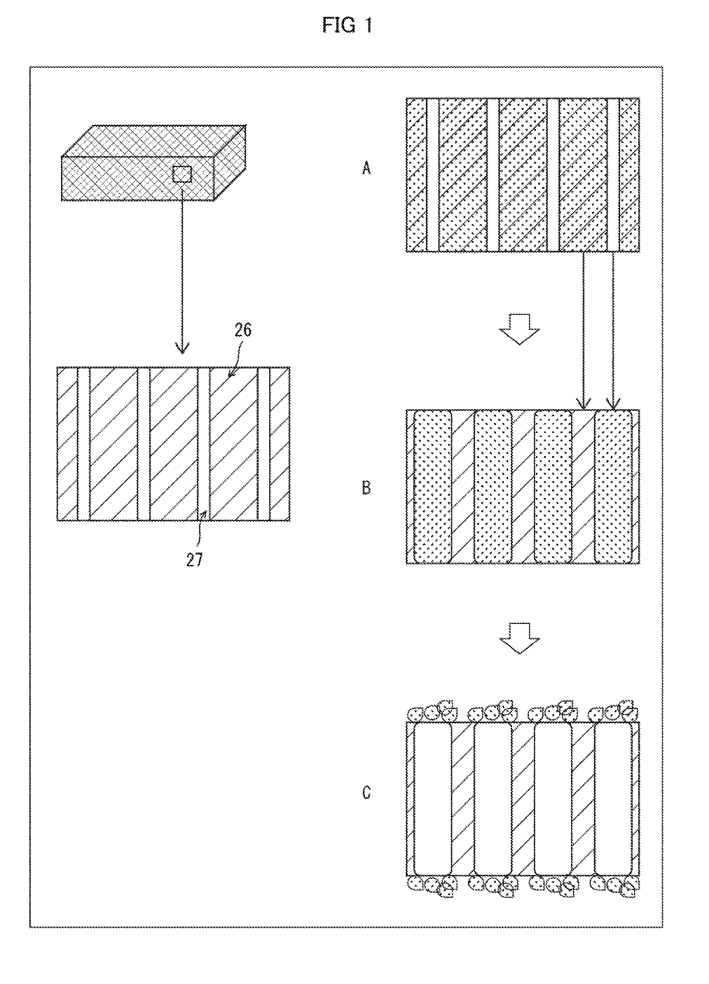

With reference to FIGS. 1 to 5, the following description will discuss a water correction method by use of the water collecting device 101. First, when the water collecting device 101 is turned on, the air blowing fan 8 inside the water collecting device 101 is turned on, which in turn causes air (moist air 12) to be taken into the water collecting device 101 through the air inlet 5 and flow through the inlet air filter 6. The moisture absorbing unit 1 is driven by the stepping motor 10 to rotate around the rotary shaft of the stepping motor 10 at predetermined time intervals and by a predetermined angle of rotation.

The air (moist air 12) that has been taken into the water collecting device 101 comes into contact with polymeric moisture absorbing materials 2 of the moisture absorbing unit 1 when passing through the moisture absorption region 25. In the moisture absorption region 25, the heater 4 is not turned on. The polymeric moisture absorbing materials 2, which are hydrophilic at room temperature, absorb moisture present in the air (moist air 12). The moist air 12 is thus dehumidified when passing through the moisture absorption region 25. Then, air (dry air 13) that has been obtained by dehumidifying the moist air 12 is discharged through the air outlet 7.

The individual elements of the moisture absorbing unit 1, which have absorbed moisture present in the air (moist air 12), are driven by the stepping motor 10 so as to sequentially move from the moisture absorption region 25 to the release region 24. In the release region 24, the heater electrode of the heater 4 of each element comes into contact with a heater-specific fixed electrode for conduction of electricity. This causes the polymeric moisture absorbing material 2 of the element to be heated by the heater 4. Further, when one of the individual elements reaches the lowermost position in the water collecting device 101 as a result of rotation of the moisture absorbing unit 1, ultrasonic vibration is provided to the heater 4 of the element at a predetermined time point.

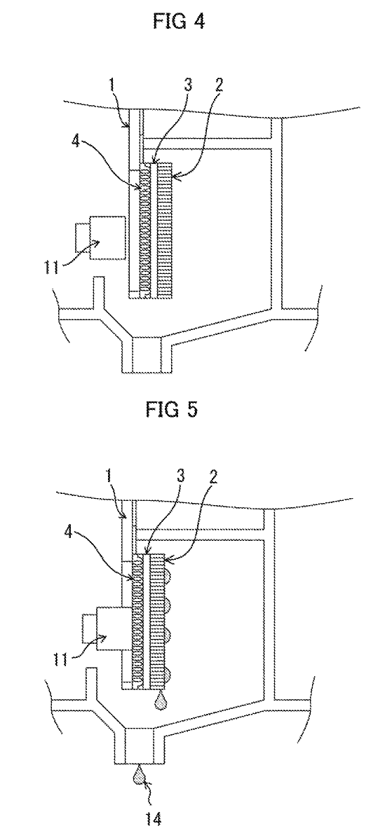

Since the heater 4 heats the base material 3 and heats the polymeric moisture absorbing material 2 through the base material 3, the temperature of the polymeric moisture absorbing material 2 reaches an LCST or higher, so that the polymeric moisture absorbing material 2 has a decreased affinity with water to become hydrophobic. This causes the moisture absorbed by the polymeric moisture absorbing material 2 to be released from the polymeric moisture absorbing material 2 in the form of liquid water. The water thus released either remains in pores in the polymeric moisture absorbing material 2 or exudes from the polymeric moisture absorbing material 2 in trace amounts. Thus, it is difficult to extract such a small amount of water released from the polymeric moisture absorbing material 2. An embodiment of the present invention can use ultrasonic vibration to extract the small amount of released water so that the released water appears on a surface of the polymeric moisture absorbing material 2. FIG. 4 is a diagram illustrating an element of the moisture absorbing unit 1 in a state where (i) the element has moved to the lowermost position in the water collecting device 101 as a result of rotation of the moisture absorbing unit 1 and (ii) an ultrasonic vibrator 11 has not yet come into contact with the heater 4 of the element. At this stage, water released from the polymeric moisture absorbing material 2 has not yet been extracted to appear on a surface of the polymeric moisture absorbing material 2. FIG. 5 is a diagram illustrating an element of the moisture absorbing unit 1 in a stare where (i) the element has moved to the lowermost position in the water collecting device 101 as a result of rotation of the moisture absorbing unit 1 and (ii) an ultrasonic vibrator 11 has come into contact with the heater 4 of the element. When ultrasonic vibration is transmitted to the polymeric moisture absorbing material 2 via the base material 3, the released water is extracted to appear on the surface of the polymeric moisture absorbing material 2 and collected. Consequently, the water thus collected is discharged in the form of dripping water 14 into the water drain tank 9.

In a case where the polymeric moisture absorbing material 2 is a porous material, in particular, it is capable of absorbing a larger amount of water rapidly. It is, however, extremely difficult to recover the water thus absorbed. FIG. 1 shows diagrams schematically illustrating how water (water vapor) in air is absorbed and released in a case where the polymeric moisture absorbing material 2 is a porous material. A porous, polymeric moisture absorbing material has a large number of pores 27 in a bulk portion 26 thereof. FIG. 1 illustrates in “A” a polymeric moisture absorbing material being hydrophilic. In this state, water in air is absorbed by the polymeric moisture absorbing material and present in the bulk portion of the polymeric moisture absorbing material (see the dots in “A” of FIG. 1). In a case where the affinity with water of this polymeric moisture absorbing material, which has absorbed water, has been decreased in response to an external stimulus and the polymeric moisture absorbing material has become hydrophobic, the polymeric moisture absorbing material releases water (see “B” in FIG. 1). The water thus released exudes from the bulk portion of the polymeric moisture absorbing material and then remains in the pores. An embodiment of the present invention, in a case where the polymeric moisture absorbing material is a porous material, uses a vibration section such as an ultrasonic vibrator for vibration of the polymeric moisture absorbing material to extract the water remaining in the pores from the polymeric moisture absorbing material (see “C” of FIG. 1).

An embodiment of the present invention uses the polymeric moisture absorbing material 2 containing a stimuli-responsive polymer whose affinity with water reversibly changes in response to an external stimulus. This embodiment of the present invention (i) decreases the affinity with water of the polymeric moisture absorbing material 2 by providing an external stimulus to the polymeric moisture absorbing material 2 so that water absorbed in the polymeric moisture absorbing material 2 will be released from the polymeric moisture absorbing material 2 and at the same time, (ii) provides vibration to the polymeric moisture absorbing material 2 whose affinity with water has been decreased. This makes it possible to efficiently collect water released from the polymeric moisture absorbing material 2.

In a case where the polymeric moisture absorbing material 2 contains a responsive polymer having an LCST higher than room temperature, for example, a relatively low temperature that is 40° C. or higher, for example, within a range of 40° C. to 100° C., preferably within a range of 40° C. to 70° C., a humidity control device including such a polymeric moisture absorbing material 2 can, without requiring supercooling or a large heat quantity as with conventional humidity control devices, simply heat the polymeric moisture absorbing material to a temperature not lower than the LCST to directly extract absorbed moisture in liquid form.

Embodiment 1 is configured such that a plurality of elements each including a polymeric moisture absorbing material 2 are arranged radially and rotated. This configuration makes it possible to (i) use elements in the moisture absorption region 25 for moisture absorption and (ii) provide a stimulus and vibration to the polymeric moisture absorbing material 2 of each remaining element in the release region 24 for water extraction. That is, it is possible to simultaneously carry out moisture absorption and release.

The material for a base material 3 is not limited to any particular one as long as beat of a heater 4 can be transmitted to a polymeric moisture absorbing material 2 via the base material 3. Examples of a material suitable for the base material 3 include metals such as aluminum and stainless steel. Examples of the material for the base material 3 further include (i) resins such as polydimethylsiloxane (PDMS), polycarbonate (PC), polyolefin, and polyacrylate, (ii) silica, and (iii) ceramic. In a case where the base material 3 is made of polydimethylsiloxane (PDMS) or the like, the base material 3 preferably has a surface coated with (i) a photothermal conversion material such as carbon black or iron oxide particles or (ii) a magnetic-thermal conversion material such as iron oxide ceramic particles or magnetite nanoparticles. This makes it possible to heat the base material 3 through, for example, light irradiation or a magnetic field and thereby heat the polymeric moisture absorbing material 2.

The method for disposing a polymeric moisture absorbing material 2 on a base material 3 is not limited to any particular one, and may be, for example, a method that uses a binder, a silane coupling agent, or the like.

The example described above is configured such that a polymeric moisture absorbing material 2 is disposed on a plate-shaped base material 3 to form a stack, that a plate-shaped heater 4 is provided on the stack on the side of the base material 3 to be in contact with the base material 3, and that an ultrasonic vibrator 11 is placed at a position that allows the ultrasonic vibrator 11 to come into contact with the heater 4 to transmit ultrasonic vibration to the heater 4. The ultrasonic vibrator 11 may alternatively be placed at a position that allows the ultrasonic vibrator 11 to come into contact with the polymeric moisture absorbing material 2 to transmit ultrasonic vibration directly to the polymeric moisture absorbing material 2. Further, the example described above is configured such that a polymeric moisture absorbing material 2 is disposed on a plate-shaped base material 3 to form a stack and that a plate-shaped heater 4 is provided on the stack on the side of the base material 3 to be in contact with the base material 3. The heater 4 may alternatively be provided on the stack on the side of the polymeric moisture absorbing material 2. In this arrangement, the ultrasonic vibrator 11 may be placed at a position that allows the ultrasonic vibrator 11 to come into contact with the heater 4 to transmit ultrasonic vibration to the heater 4. The ultrasonic vibrator 11 may alternatively be placed at a position that allows the ultrasonic vibrator 11 to come into contact with the base material 3 to transmit ultrasonic vibration to the polymeric moisture absorbing material 2.

In the example described above, the ultrasonic vibrator 11 is used as a vibration section for extracting water which exudes from the polymeric moisture-absorbing material 2, by vibrating the polymeric moisture-absorbing material 2. The vibration section is, however, not limited to any particular configuration and may be any vibration section that can provide vibration at a frequency in an ultrasonic range. Further, examples of the vibration section other than the ultrasonic vibrator include a magnet which oscillates in response to high-frequency wave application, an electret, a magnetostrictive vibrator such as Fe—Ga, a crystal oscillator, and a self-oscillating polymeric gel. Meanwhile, the vibration section may include a resonator.

In the example described above, the water collecting device 101 includes a housing, an air inlet 5, an inlet air filter 6, an air blowing fan 8, an air outlet 7, and a water drain tank 9. This water collecting device 101 is usable by itself as a humidity control device as well. The water collecting device 101 may alternatively be configured to not include the above members and to include only a water collecting section. The water collecting device 101 may, in other words, be a device which includes at least a moisture absorbing unit 1, a stepping motor 10, and an ultrasonic vibrator 11. The water collecting device 101 can, in this case, be incorporated in a humidity control device as a component thereof.

The example described above uses a plate-shaped heater 4 to provide a thermal stimulus to a polymeric moisture absorbing material 2 efficiently. The shape of the heater 4 is, however, not limited to that of a plate, and may be any shape that allows the heater 4 to be placed along the polymeric moisture absorbing material 2. Any heating device other than a heater 4 may alternatively be used as long as heat as a stimulus can be applied to the polymeric moisture absorbing material 2. Examples of such a heating device include a halogen lamp, an infrared lamp, and a xenon lamp.

The example described above uses a plate-shaped or layer-shaped polymeric moisture absorbing material as the polymeric moisture absorbing material 2. The shape of the polymeric moisture absorbing material 2 is, however, also not limited to a plate or layer. The polymeric moisture absorbing material 2 may be, for example, in the form of particles.

In the example described above, the moisture absorbing unit 1 includes 12 elements described above. The number of elements is, however, not limited to 12. Further, in the example described above, there are three elements in the release region 24 and nine elements in the moisture absorption region 25. The ratio is, however, not limited to this, and may be changed as appropriate.

In the example described above, the moisture absorbing unit 1 is driven by the stepping motor 10 and is configured to be rotated at predetermined time intervals and by a predetermined angle of rotation. The moisture absorbing unit 1 may alternatively be rotated in response to a user's instruction or in a case where a sensor provided on the airflow path in the moisture absorption region 25 to sense the amount of moisture absorption has sensed that the amount of moisture absorption has reached a predetermined value or higher.

The water collecting device 101 may include a heater-specific fixed electrode(s) and an ultrasonic vibrator(s) 11 that are each positioned so as to come into contact with the heater 4 of an element(s) among the elements present in the release region 24 or with the heater 4 of a single one of the elements present in the release region 24. The water collecting device 101 may, for example, include a heater-specific fixed electrode and an ultrasonic vibrator 11 that are each positioned so as to come into contact with the heater 4 of an element that has reached the lowermost position in the water collecting device 101. The water collecting device 101 may alternatively be configured such that only a heater-specific fixed electrode(s) is positioned so as to come into contact with the heater 4 of an element(s) among the elements present in the release region 24 and that only an ultrasonic vibrator(s) 11 is positioned so as to come into contact with another element(s) among the elements present in the release region 24.

The example described above uses, as the polymeric moisture absorbing material 2, a polymeric moisture absorbing material containing a temperature-responsive polymer having an LCST. The polymeric moisture absorbing material may, however, alternatively contain a temperature-responsive polymer having no LCST or a stimuli-responsive polymer that responds to another stimulus. In a case where the polymeric moisture absorbing material contains a stimuli-responsive polymer that responds to another stimulus, the heater 4 may simply be replaced with a device configured as a stimulus providing section to provide such another stimulus, for example, light such as infrared radiation, ultraviolet radiation, or visible light, or electric field.

In the example described above, water extracted to appear on the surface of the polymeric moisture-absorbing material 2 is collected in the form of dripping water 14, and then discharged into the water drain tank 9. The water extracted can be alternatively collected by, for example, a centrifugal method which includes high-speed rotation.

The shape of each element included in the moisture absorbing unit 1, the intervals between the elements, the shape of the airflow restriction wall 23, the position of the water drain tank 9, the shape of the housing, and the like are not limited to those illustrated in FIGS. 2 and 3, and may be changed as appropriate.

### Embodiment 2

The following description will discuss another embodiment of the present invention in detail.

For convenience of explanation, any member of Embodiment 2 that is identical in function to a corresponding member of Embodiment 1 is assigned a common reference sign, and is not described here.

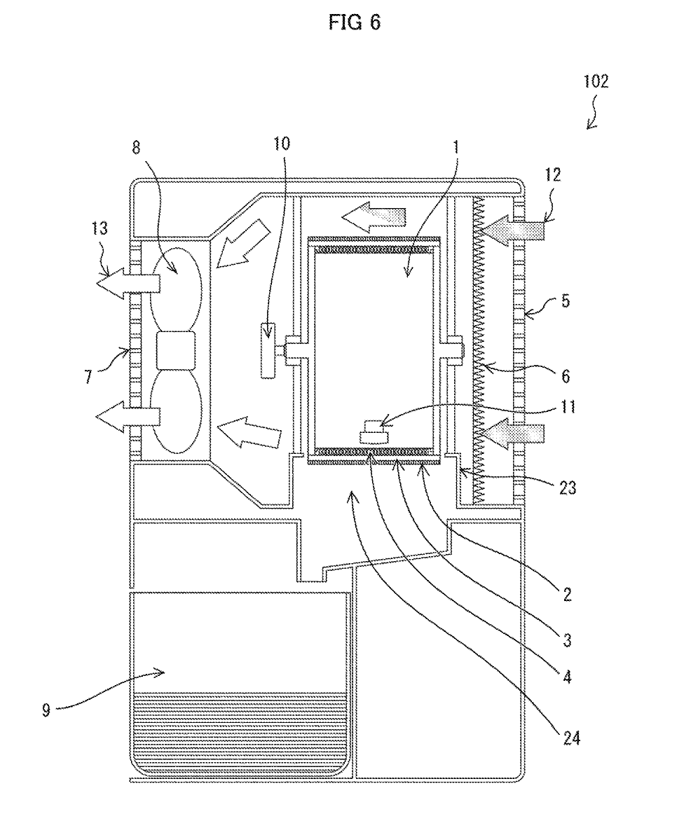

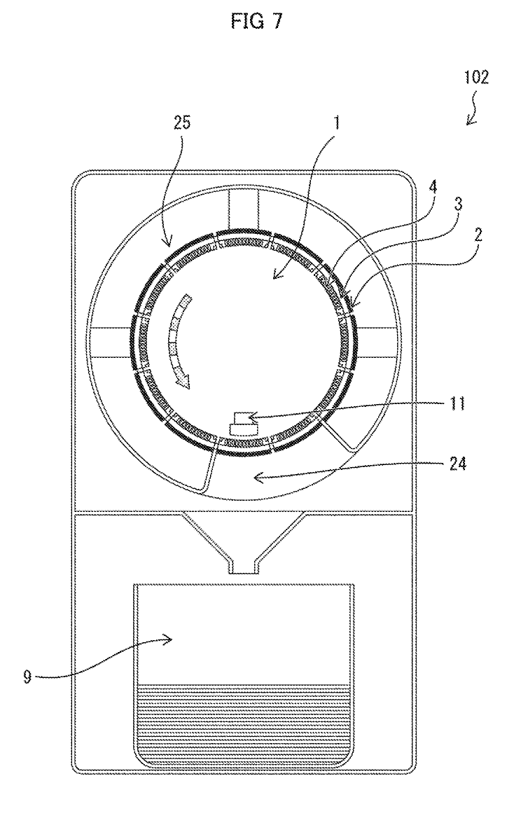

FIG. 6 is a longitudinal cross-sectional view of a water collecting device 102 in accordance with Embodiment 2 of the present invention. FIG. 7 is a transverse cross-sectional view of the water collecting device 102.

Embodiment 2 includes an air blowing fan 8 positioned so as to be close to an air outlet. This means that air flows along a path on which are provided an air inlet 5, an inlet air filter 6, a moisture absorbing unit 1, the air blowing fan 8, and the air outlet 7 in this order from the side of the entry of air.

The moisture absorbing unit 1, as illustrated in FIGS. 6 and 7, includes a plurality of elements fixed to the side surface of a cylinder, each of the plurality of elements including a base material 3, a polymeric moisture absorbing material 2 disposed on the base material 3 to form a stack, and a heater 4 on the stack on the side of the base material 3 to be in contact with the base material 3. The cylinder is contained in the water collecting device 102 and has a central axis that coincides with the rotary shaft of a stepping motor 10 which rotary shaft extends in a direction perpendicular to that side surface of the housing in which the air inlet 5 is present. The individual elements are arranged next to each other at even intervals on the side surface of the cylinder. The moisture absorbing unit 1 is rotatable about on the rotary shaft of the stepping motor 10 in the direction indicated with the arrow in FIG. 7 (counterclockwise). The moisture absorbing unit 1 is driven by the stepping motor 10 to rotate.

FIG. 7 is a transverse cross-sectional view of the water collecting device 102 along a cross section which is parallel to that side surface of the housing in which the air inlet 5 is present, the cross section equally dividing the cylinder into two portions. Embodiment 2 is configured such that the individual elements of the moisture absorbing unit 1 each have a transverse cross section in the shape of a circular arc such that the individual elements together form a cylinder when arranged close to one another on the side surface of the cylinder. In other words, the combination of the base material 3, the polymeric moisture absorbing material 2, and the heater 4 has a transverse cross section having the shape of a plate curved in the form of a circular arc. The individual elements of the moisture absorbing unit 1 are each configured in such a manner that the polymeric moisture absorbing material 2 is positioned on an outer side of the circular arc, and the heater 4 is positioned on an inner side of the circular arc. The moisture absorbing unit 1 is driven by the stepping motor 10 and is configured to be rotated at predetermined time intervals and by a predetermined angle of rotation.

As illustrated in FIG. 7, the moisture absorbing unit 1 is rotated in a region divided into (i) a moisture absorption region 25, which is positioned in an upper portion of the water collecting device 102, and (ii) a release region 24, which is positioned in a lower portion of the water collecting device 102. Each time the moisture absorbing unit 1 is rotated at the predetermined time interval and by the predetermined angle of rotation, one of the individual elements moves from the moisture absorption region 25 into the release region 24, and another one of the individual elements moves from the release region 24 into the moisture absorption region 25. Embodiment 2 is configured such that two elements positioned in a lower portion of the water collecting device 102 are in the release region 24. The water collecting device 102 includes in the release region 24 a heater-specific fixed electrode (not shown in the drawings) positioned so as to, for conduction of electricity to the heater 4 of the element that has last entered the release region 24 and that is positioned at the lowermost position, come into contact with a heater electrode of that heater 4. With this configuration, when the individual elements of the moisture absorbing unit 1 are each driven by the stepping motor 10 to rotate to reach the release region 24, the heater 4 of the element is supplied with electricity and turned on.

Further, the water collecting device 102 includes an ultrasonic vibrator 11 in the release region 24. The ultrasonic vibrator 11 is positioned such that when one of the individual elements reaches the lowermost position in the water collecting device 102 as a result of rotation of the moisture absorbing unit 1, the ultrasonic vibrator 11 is close to the heater 4 of the element. Then, when one of the individual elements reaches the lowermost position in the water collecting device 102 as a result of rotation of the moisture absorbing unit 1, the ultrasonic vibrator 11 is controlled by a control section (not shown in the drawings) so as to come in contact with the heater 4 at a predetermined time point and then to transmit ultrasonic vibration to the heater 4. The ultrasonic vibrator 11 provides ultrasonic vibration to each polymeric moisture-absorbing material 2 via the heater 4 and the base material 3 of the element.

With an airflow restriction wall 23, air that has been taken in through the air inlet 5 passes through only the moisture absorption region 25 and is prevented from flowing through the release region 24.

At the bottom of the release region 24, the water collecting device 102 has a drip opening, which allows collected water to be discharged into a water drain tank 9 under the drip opening.

With reference to FIGS. 6 to 9, the following description will discuss a water correction method by use of the water collecting device 102. First, when the water collecting device 102 is turned on, the air blowing fan 8 inside the water collecting device 102 is turned on, which in turn causes air (moist air 12) to be taken into the water collecting device 102 through the air inlet 5 and flow through the inlet air filter. The moisture absorbing unit 1 is driven by the stepping motor 10 to rotate around the rotary shaft of the stepping motor 10 at predetermined time intervals and by a predetermined angle of rotation.

The air (moist air 12) that has been taken into the water collecting device 102 comes into contact with polymeric moisture absorbing materials 2 of the moisture absorbing unit 1 when passing through the moisture absorption region 25. In the moisture absorption region 25, the heater 4 is not turned on. The polymeric moisture absorbing materials 2, which are hydrophilic at room temperature, absorb moisture present in the air (moist air 12). The moist air is thus dehumidified when passing through the moisture absorption region 25. Then, air (dry air 13) that has been obtained by dehumidifying the moist air is discharged through the air outlet 7.

The individual elements of the moisture absorbing unit 1, which have absorbed moisture present in the air (moist air 12), are driven by the stepping motor 10 so as to sequentially move from the moisture absorption region 25 to the release region 24. In the release region 24, the heater electrode of the heater 4 of each element comes into contact with a heater-specific fixed electrode for conduction of electricity. This causes the polymeric moisture absorbing material 2 of the element to be heated by the heater 4. Further, ultrasonic vibration is provided to the heater 4 of the element.

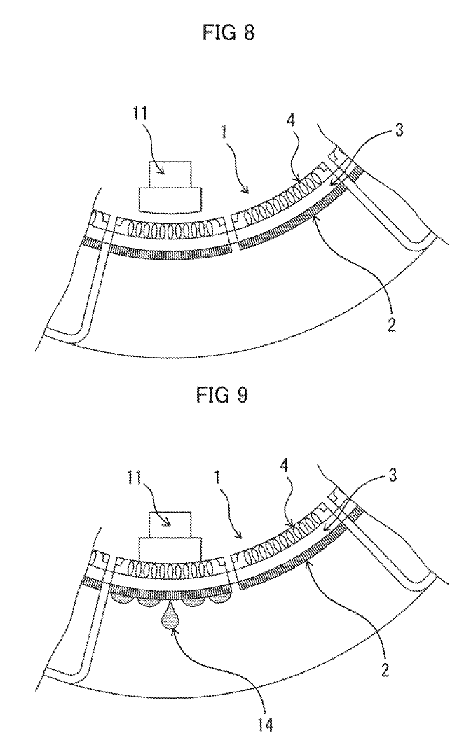

Since the heater 4 heats the base material 3 and heats the polymeric moisture absorbing material 2 through the base material 3, the temperature of the polymeric moisture absorbing material 2 reaches an LCST or higher, so that the polymeric moisture absorbing material 2 has a decreased affinity with water to become hydrophobic. This causes the moisture absorbed by the polymeric moisture absorbing material 2 to be released from the polymeric moisture absorbing material 2 in the form of liquid water. FIG. 8 is a diagram illustrating an element of the moisture absorbing unit 1 in a state where (i) the element has moved to the lowermost position in the water collecting device 102 as a result of rotation of the moisture absorbing unit 1 and (ii) an ultrasonic vibrator 11 has not yet come into contact with the heater 4 of the element. At this stage, water released from the polymeric moisture absorbing material 2 has not yet been extracted to appear on a surface of the polymeric moisture absorbing material 2. FIG. 9 is a diagram illustrating an element of the moisture absorbing unit 1 in a state where (i) the element has moved to the lowermost position in the water collecting device 102 as a result of rotation of the moisture absorbing unit 1 and (ii) an ultrasonic vibrator 11 has come into contact with the heater 4 of the element. When ultrasonic vibration is transmitted to the polymeric moisture absorbing material 2 via the base material 3, the water released is extracted to appear on the surface of the polymeric moisture absorbing material 2 and collected. Consequently, the water thus collected is discharged in the form of dripping water 14 into the water drain tank 9.

Embodiment 2 is identical to Embodiment 1 in terms of (i) the advantageous effect obtained by (a) decreasing the affinity with water of a polymeric moisture-absorbing material which has absorbed moisture, by provision of an external stimulus to the polymeric moisture-absorbing material and at the same time (b) providing vibration to the polymeric moisture-absorbing material whose affinity with water has been decreased, and (ii) the advantageous effect obtained by rotating the moisture absorbing unit 1.

The material for the base material 3, the method for rotating the moisture absorbing unit 1, and the configuration of the vibration section are identical to those in Embodiment 1. The stimuli-responsive polymer contained in the polymeric moisture absorbing material 2, the above stimulus providing section, the shape and type of the heater 4, the shape of the polymeric moisture absorbing material 2, and the respective configurations of the stimulus providing section and the above vibration section may be varied as in Embodiment 1.

Note that in the example described above, the individual elements of the moisture absorbing unit 1 are each configured such that the polymeric moisture absorbing material 2 is positioned on an outer side of the circular arc and that the heater 4 is positioned on an inner side of the circular arc. Alternatively, the individual elements of the moisture absorbing unit 1 may be configured in a reversed manner such that the polymeric moisture absorbing material 2 is positioned on an inner side of the circular arc and that the heater 4 is positioned on an outer side of the circular arc. In such a case, the heater-specific fixed electrode is positioned outside of the moisture absorbing unit 1.

### Embodiment 3

The following description will discuss yet another embodiment of the present invention in detail.

For convenience of explanation, any member of Embodiment 3 that is identical in function to a corresponding member of Embodiment 1 is assigned a common reference sign, and is not described here.

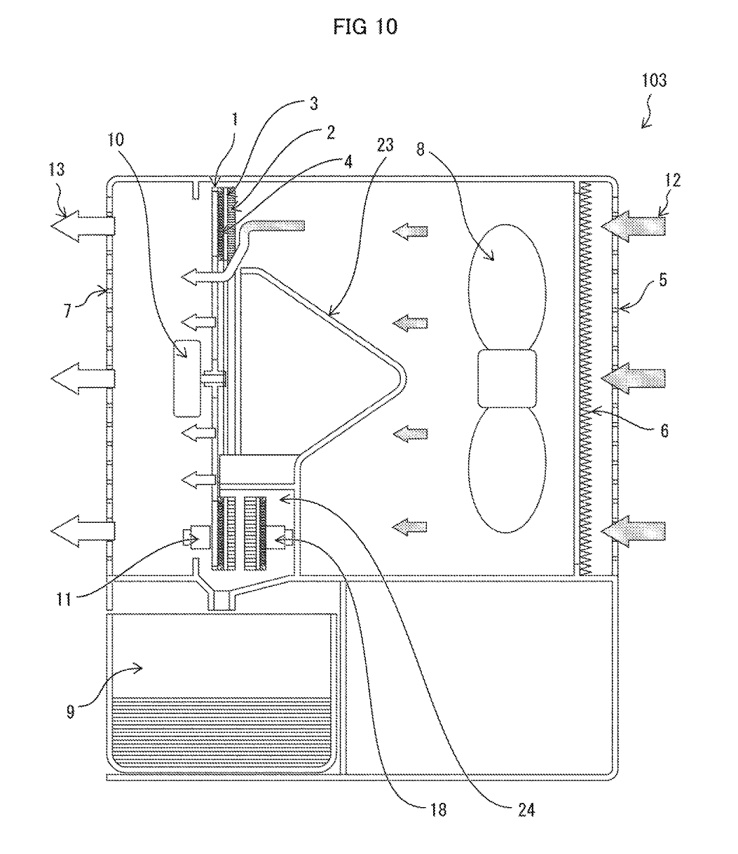

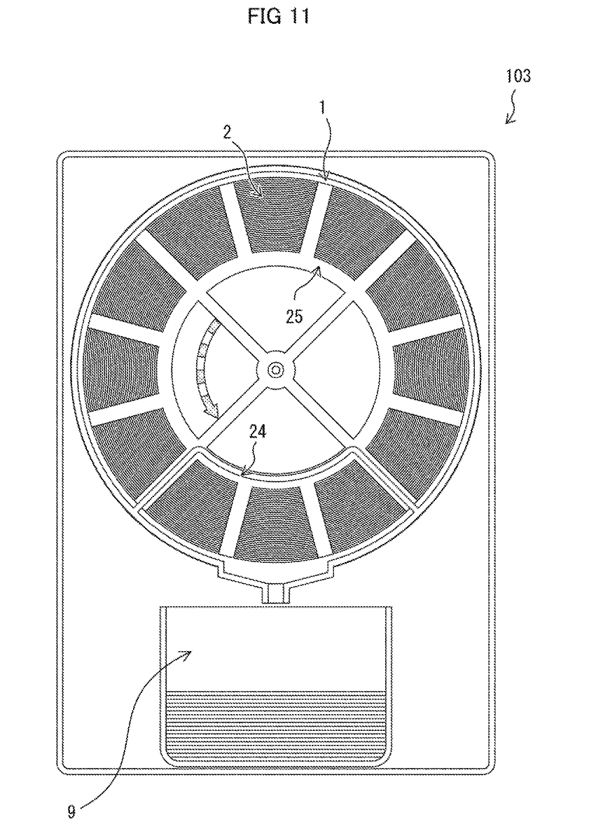

FIG. 10 is a longitudinal cross-sectional view of a water collecting device 103 in accordance with Embodiment 3 of the present invention. FIG. 11 is a transverse cross-sectional view of the water collecting device 103.

Embodiment 3 is a modification of Embodiment 1. Embodiment 3 is different from Embodiment 1 in only a configuration of a release region 24. In other words, as illustrated in FIGS. 10 and 11, Embodiment 3 includes a water collecting element configured to face an element, which has moved to the lowermost position as a result of rotation of a main moisture absorbing unit 1. The water collecting element is a member which includes a plate-shaped secondary heater 17. In the water collecting element, the plate-shaped secondary heater 17 is provided on the side of a secondary base material 16 of a stack, which includes the secondary base material 16 having a rectangular plate shape and a secondary polymeric moisture absorbing material 15 disposed on the secondary base material 16, such that the secondary heater 17 is in contact with the secondary base material 16. Further, the water collecting element is provided with a secondary ultrasonic vibrator 18 such that the secondary ultrasonic vibrator 18 is in contact with the secondary heater 17. This allows the secondary ultrasonic vibrator 18 to transmit ultrasonic vibration to the secondary heater 17.

In the water collecting element, the secondary polymeric moisture-absorbing material 15 is provided so as to face a main polymeric moisture-absorbing material 2 of an element which has moved to the lowermost position as a result of rotation of the main moisture absorbing unit 1. The secondary polymeric moisture-absorbing material 15 is provided in parallel with the main polymeric moisture-absorbing material 2 at the lowermost position and faces this main polymeric moisture-absorbing material 2 at a predetermined distance apart from the main polymeric moisture-absorbing material 2. It is possible to control, with use of a control section (not shown in the drawings), heating of the water collecting element by the secondary heater 17, vibration provided to the water collecting element by the secondary ultrasonic vibrator 18, and a horizontal forward-and-backward motion of the water collecting element for changing a distance between the secondary polymeric moisture-absorbing material 15 and the main polymeric moisture-absorbing material 2.

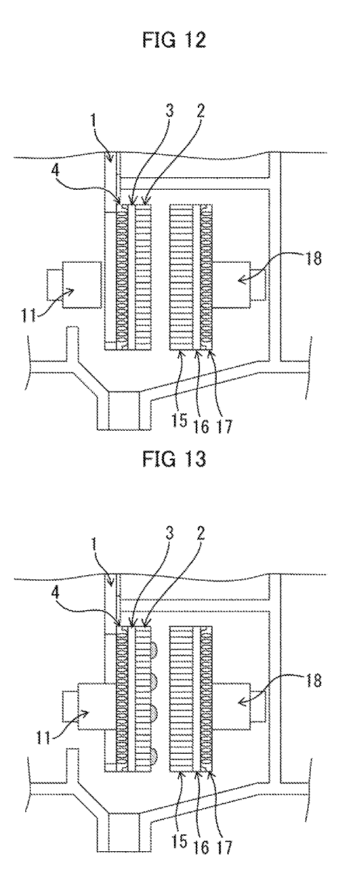

FIG. 12 is a diagram illustrating an element in a state where (i) the element has moved to the lowermost position as a result of rotation of the main moisture absorbing unit 1 and (ii) a main ultrasonic vibrator 11 has not yet come into contact with a main heater 4 of the element. At this stage, the main polymeric moisture-absorbing material 2 is releasing water, being heated by the main heater 4. The water released from the main polymeric moisture-absorbing material 2, however, has not been extracted to appear on a surface of the main polymeric moisture-absorbing material 2. On the other hand, the water collecting element is in a state in which the secondary polymeric moisture-absorbing material 15 is provided in parallel with the main polymeric moisture-absorbing material 2 so as to face the main polymeric moisture-absorbing material 2 at a predetermined distance apart from the main polymeric moisture-absorbing material 2, and the secondary heater 17 is not heated.

FIG. 13 is a diagram illustrating an element in a state where (i) the element has moved to the lowermost position in the water collecting device 103 as a result of rotation of the main moisture absorbing unit 1 and (ii) the main ultrasonic vibrator 11 has come into contact with the main heater 4 of the element. In this state, the water released is extracted to appear on the surface of the main polymeric moisture-absorbing material 2 by transmission of ultrasonic vibration to the main polymeric moisture-absorbing material 2 via the main base material 3. On the other hand, the water collecting element is in a state in which the secondary polymeric moisture-absorbing material 15 is provided in parallel with the main polymeric moisture-absorbing material 2 so as to face the main polymeric moisture-absorbing material 2 at a predetermined distance apart from the main polymeric moisture-absorbing material 2, and the secondary heater 17 is not heated.

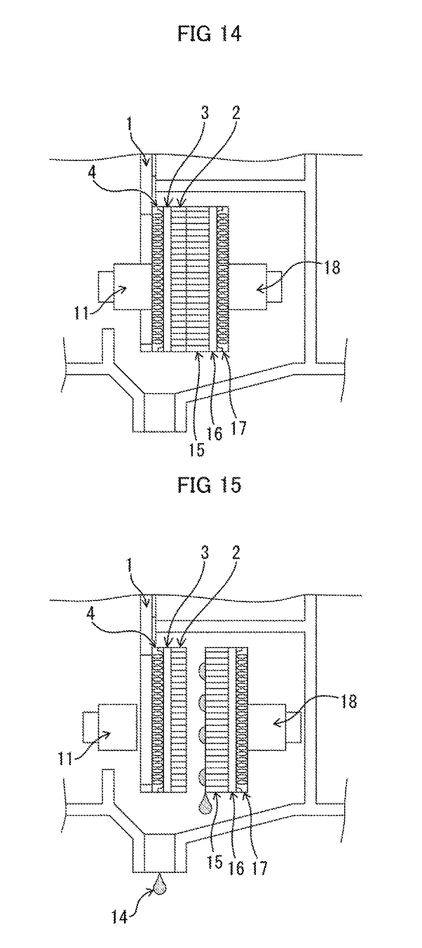

Thereafter, as illustrated in FIG. 14, the water collecting element is controlled by a control section (not shown in the drawings) so as to move in a direction toward the element of the main moisture absorbing unit 1. Consequently, the secondary polymeric moisture-absorbing material 15 comes in contact with the main polymeric moisture-absorbing material 2. In this state, since the secondary heater 17 is not turned on, the water extracted to appear on the surface of the main polymeric moisture-absorbing material 2 is transferred to the secondary polymeric moisture-absorbing material 15 of the water collecting element, which secondary polymeric moisture-absorbing material 15 is hydrophilic at room temperature.

After the water extracted to appear on the main polymeric moisture-absorbing material 2 has been transferred to the secondary polymeric moisture-absorbing material 15 of the water collecting element, the water collecting element is controlled by the control section (not shown in the drawings) so as to move in a direction which allows the water collecting element to go back apart from the element which has moved to the lowermost position. This increases the distance between the secondary polymeric moisture-absorbing material 15 and the main polymeric moisture-absorbing material 2 back to the predetermined distance that is an original distance.

The steps illustrated in FIGS. 12 to 14 are repeated every time one of individual elements of the main moisture absorbing unit 1 moves to the lowermost position. After water released from the main polymeric moisture-absorbing material 2 has been transferred to the secondary polymeric moisture-absorbing material 15 of the water collecting element a predetermined number of times, the water collecting element is controlled by the control section (not shown in the drawings) so as to move back apart from the element which has moved to the lowermost position. Thereafter, the secondary polymeric moisture-absorbing material 15 of the water collecting element is heated by the secondary heater 17, and at the same time, the secondary ultrasonic vibrator 18 provides vibration to the secondary heater 17 of the water collecting element.

As a result, as illustrated in FIG. 15, ultrasonic vibration is transmitted to the secondary polymeric moisture-absorbing material 15 via the secondary base material 16 due to a contact between the secondary ultrasonic vibrator 18 and the secondary heater 17. This causes the water released from the secondary polymeric moisture-absorbing material 15 to be extracted to appear on the surface of the secondary poly merle moisture-absorbing material 15, so that the water is collected. The water thus collected is discharged as dripping water 14 into a water drain tank 9.

Embodiment 3 makes it possible to accumulate, in the water collecting element, water which has been absorbed as moisture into each element of the main moisture absorbing unit 1, and then to collect accumulated water at one time from the water collecting element which has fully absorbed water.

### Embodiment 4

The following description will discuss yet another embodiment of the present invention in detail.

For convenience of explanation, any member of Embodiment 4 that is identical in function to a corresponding member of Embodiment 1 is assigned a common reference sign, and is not described here.

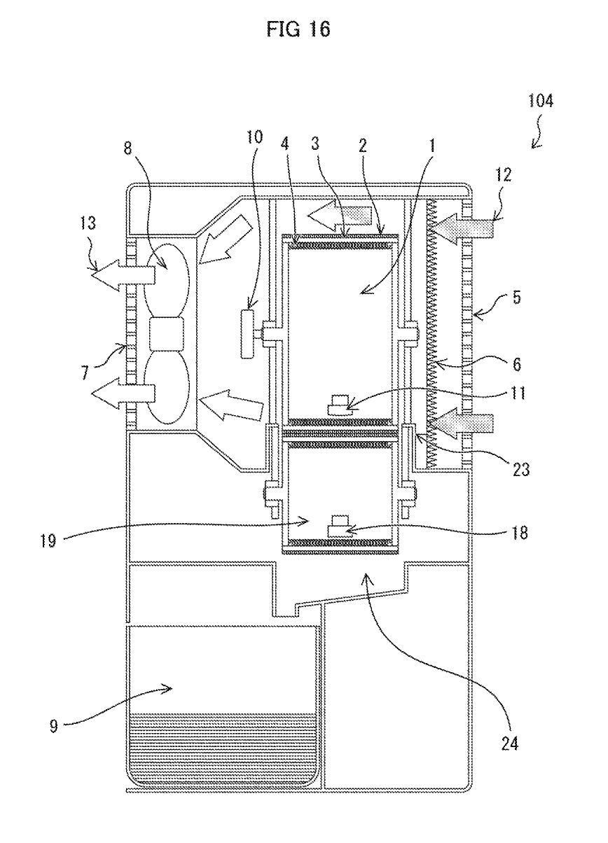

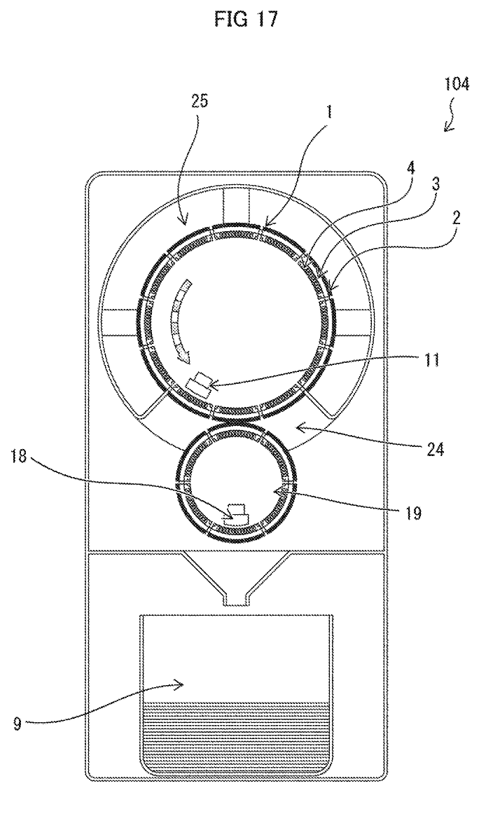

FIG. 16 is a longitudinal cross-sectional view of a water collecting device 104 in accordance with Embodiment 4 of the present invention. FIG. 17 is a transverse cross-sectional view of the water collecting device 104.

Embodiment 4 is a modification of Embodiment 2. Embodiment 4 is different from Embodiment 2 in only a configuration of a release region 24. In other words, as illustrated in FIGS. 16 and 17, Embodiment 4 is provided, in the release region 24, with a cylindrical secondary moisture absorbing unit 19 which has a side surface in contact with a side surface of a cylinder to which a plurality of elements of a main moisture absorbing unit 1 are fixed. The secondary moisture absorbing unit 19 is arranged to rotate as the moisture absorbing unit 1 rotates.

The secondary moisture absorbing unit 19 is a member in which a plurality of water collecting elements are fixed to a side surface of a cylinder. The water collecting elements each include a secondary heater 17 which is provided on the side of a secondary base material 16 of a stack, which includes the secondary base material 16 and a secondary polymeric moisture absorbing material 15 disposed on the secondary base material 16, so as to be in contact with the secondary base material 16.

Further, the secondary moisture absorbing unit 19 includes a heater-specific fixed electrode (not shown in the drawings). The heater-specific fixed electrode is positioned so as to, for conduction of electricity to the secondary heater 17 of the water collecting element, come into contact with a heater electrode of the secondary heater 17 which has moved to the lowermost position of the cylinder of the secondary moisture absorbing unit 19 as a result of rotation of the secondary moisture absorbing unit 19. Further, the secondary moisture absorbing unit 19 is also provided with a secondary ultrasonic vibrator 18 which is positioned such that when one of the water collecting elements reaches the lowermost position of the cylinder as a result of rotation of the secondary moisture-absorbing unit 19, the secondary ultrasonic vibrator 18 comes close to the secondary heater 17 of the water collecting element. When the water collecting element of the secondary moisture absorbing unit 19 reaches the lowermost position of the cylinder, the secondary ultrasonic vibrator 18 is caused, by a control section (not shown in the drawings), to come in contact with the secondary heater 17 at a predetermined time point and then to transmit ultrasonic vibration to the secondary heater 17. The secondary ultrasonic vibrator 18 provides ultrasonic vibration to the secondary polymeric moisture-absorbing material 15 via the secondary heater 17 and the secondary base material 16 of the water collecting element.

Embodiment 4 is configured such that three elements in a lower portion of the water collecting device 104 are in the release region 24. The water collecting device 104 includes, in the release region 24, a heater-specific fixed electrode (not shown in the drawings) positioned so as to, for conduction of electricity to the main heater 4 of the element that has last entered the release region 24, come into contact with a heater electrode of that main heater 4. The water collecting device 104 also includes a main ultrasonic vibrator 11 at the position close to a main heater 4 of an element which has last entered the release region 24. With this configuration, when the elements of the main moisture absorbing unit 1 are each driven by a stepping motor 10 to rotate to reach the release region 24, the main heater 4 of the element is supplied with electricity and turned on. Further, in the element in which the main heater 4 is operable, the main ultrasonic vibrator 11 is controlled by a control section (not shown in the drawings) so as to come in contact with the main heater 4 at a predetermined time point and then to transmit ultrasonic vibration to the main heater 4. The main ultrasonic vibrator 11 provides ultrasonic vibration to each main polymeric moisture-absorbing material 2 via the main heater 4 and the main base material 3 of the element.

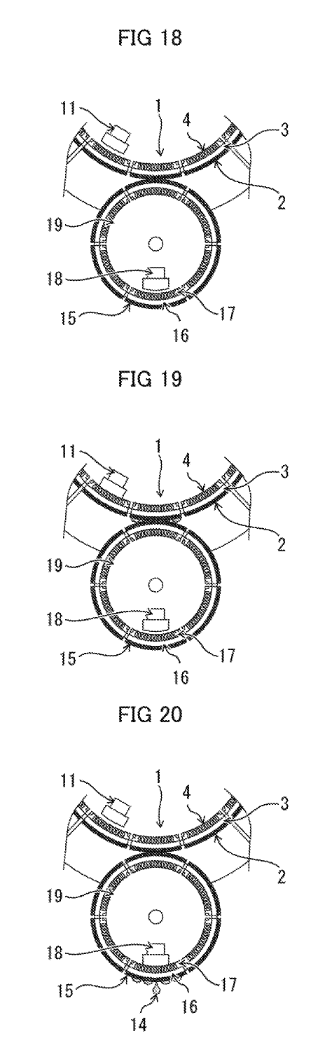

FIG. 18 is a diagram illustrating an element in a state where (i) the element has moved into the release region 24 as a result of rotation of the main moisture absorbing unit 1 and (ii) the main ultrasonic vibrator 11 has not yet come into contact with the main heater 4 of the element. At this stage, the main polymeric moisture-absorbing material 2 is releasing water, being heated by the main heater 4. The water released from the main polymeric moisture-absorbing material 2, however, has not been extracted to appear on a surface of the main polymeric moisture-absorbing material 2. FIG. 19 is a diagram illustrating an element in a state where the main ultrasonic vibrator 11 has come into contact with the main heater 4 of the element. This causes the water released as above to be extracted to appear on the surface of the main polymeric moisture-absorbing material 2. Then, the element where the water released has been extracted to appear on the main polymeric moisture absorbing material 2 is moved to the lowermost position in the water collecting device 104. At this time, since the element is in contact with a water collecting element whose secondary heater 17 is not supplied with electricity in the secondary moisture absorbing unit 19, the water extracted to appear on the surface of the main polymeric moisture-absorbing material 2 is transferred to the secondary polymeric moisture-absorbing material 15 which is hydrophilic at room temperature.

In this way, the water extracted at each element of the main moisture absorbing unit 1 is sequentially transferred to the water collecting element of the secondary moisture absorbing unit 19, from the each element which moves, as a result of rotation of the main moisture absorbing unit 1, to the lowermost position of the cylinder that forms the main moisture absorbing unit 1. This makes it possible to continuously repeat (i) absorption of moisture (water) in air and release of water by each element of the main moisture absorbing unit 1 and (ii) collection of water into the water collecting element of the secondary moisture absorbing unit 19.

Thereafter, as illustrated in FIG. 20, the heater-specific fixed electrode provided at the lowermost position of the secondary moisture absorbing unit 19 is brought into contact with the secondary heater 17 at an appropriate time point, so that the secondary heater 17 is turned on. At the same time, the secondary heater is controlled to come in contact with the secondary ultrasonic vibrator 18. These allow for efficient collection of water which has been accumulated by each water collecting element of the secondary moisture absorbing unit 19.

### Embodiment 5

The following description will discuss yet another embodiment of the present invention in detail.

For convenience of explanation, any member of Embodiment 5 that is identical in function to a corresponding member of Embodiment 1 is assigned a common reference sign, and is not described here.

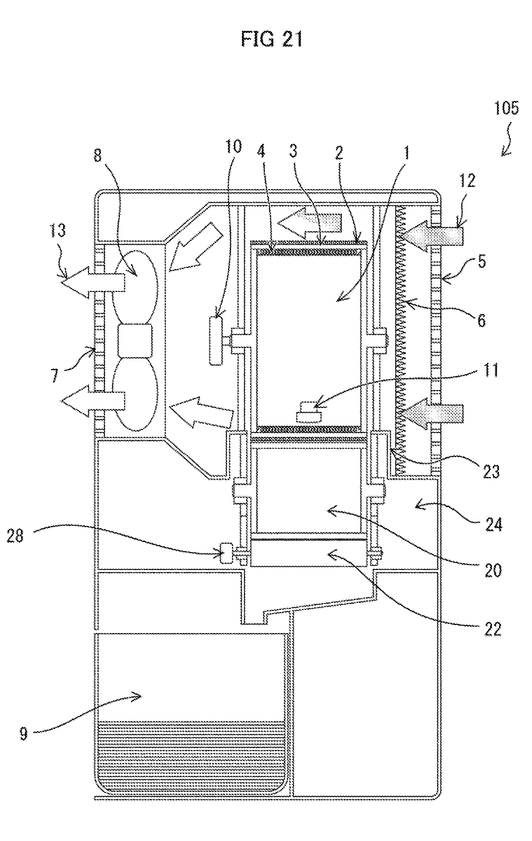

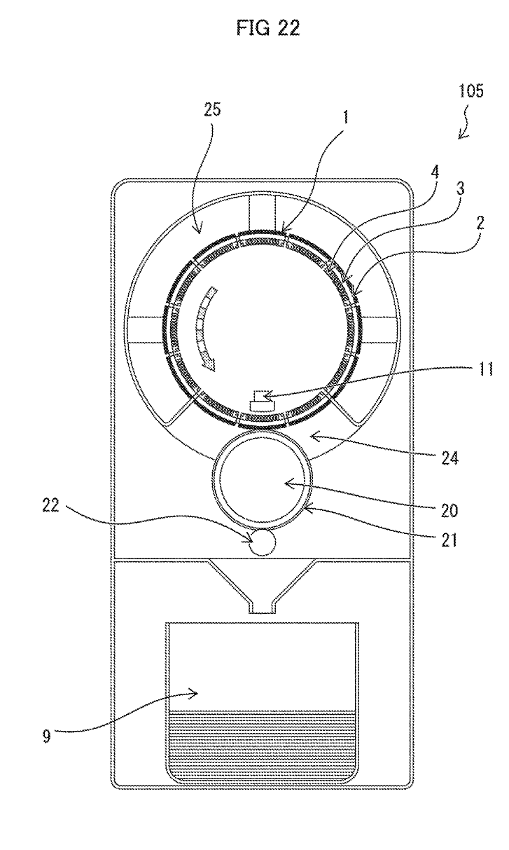

FIG. 21 is a longitudinal cross-sectional view of a water collecting device 105 in accordance with Embodiment 5 of the present invention. FIG. 22 is a transverse cross-sectional view of the water collecting device 105.

Embodiment 5 is a modification of Embodiment 2. Embodiment 5 is different from Embodiment 2 in only a configuration of a release region 24. In other words, as illustrated in FIGS. 21 and 22, Embodiment 5 is provided, in the release region 24, with a cylindrical adsorbing roller 20 which has a side surface in contact with a side surface of a cylinder to which a plurality of elements of a main moisture absorbing unit 1 are fixed. The adsorbing roller 20 is a member in which an adsorbing material 21 is fixed onto a cylindrical rotating body. The adsorbing roller 20 rotates as the moisture absorbing unit 1 rotates.

The adsorbing material 21 is made of a water-absorbent material such as sponge. Below the adsorbing roller 20, a cylindrical compression roller 22 is provided. This cylindrical compression roller 22 has a side surface in contact with the side surface of a cylinder of the adsorbing roller 20. The compression roller 22 is driven by a motor 28 for the compression roller 20 such that as the adsorbing roller 20 rotates, the compression roller 22 rotates.

FIG. 24 is a diagram illustrating an element, in a state where (i) the element has moved to the lowermost position in the water collecting device 105 as a result of rotation of the moisture absorbing unit 1 and (ii) an ultrasonic vibrator 11 has come into contact with a heater 4 of the element. The heater 4 heats a polymeric moisture-absorbing material 2 of the element. Further, at the lowermost position of the cylinder of the moisture absorbing unit 1, ultrasonic vibration is provided to the heater 4. This causes water released from the polymeric moisture-absorbing material 2 to be extracted to appear on a surface of the polymeric moisture-absorbing material 2, at the element which is present at the Lowermost position of the cylinder that forms the moisture absorbing unit 1.

In this case, the water extracted to appear on the polymeric moisture-absorbing material 2 is absorbed by the adsorbing material 21 of the adsorbing roller 20 which adsorbing material 21 is in contact with the element, since the adsorbing material 21 has a water-absorbing property.

In this way, the water extracted from each element of the moisture absorbing unit 1 is sequentially transferred to the adsorbing material 21 of the adsorbing roller 20, from the each element which moves, as a result of rotation of the moisture absorbing unit 1, to the lowermost position of the cylinder that forms the moisture absorbing unit 1. This makes it possible to continuously repeat (i) absorption of moisture (water) in air and release of water by each element of the moisture absorbing unit 1 and (ii) collection of water into the adsorbing material 21 of the moisture adsorbing roller 20.

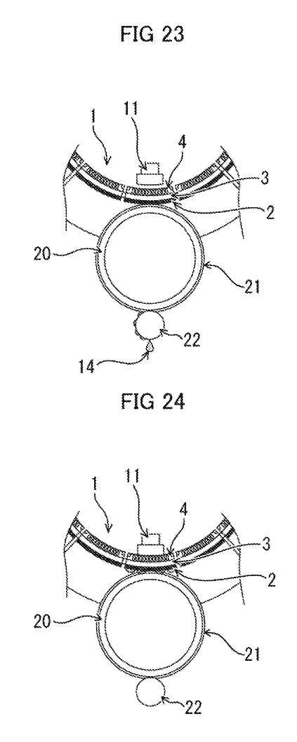

Thereafter, as illustrated in FIG. 23, water accumulated in the adsorbing material 21 of the adsorbing roller 20 can be efficiently collected by application of pressure to the adsorbing material 21 by the compression roller 22 at appropriate time points.

### Details of Polymeric Moisture Absorbing Material

The following description will discuss in detail a polymeric moisture absorbing material that contains a stimuli-responsive polymer and that is used in the embodiments described above. In the present specification, a substance that may mean either “acrylic” or “methacrylic” is expressed as “(meth)acrylic”.

The embodiments described above each use a polymeric moisture absorbing material containing a dried product of a stimuli-responsive polymer. In a case where the stimuli-responsive polymer is crosslinked, in particular, a three dimensional network structure formed by the cross-linked polymer tends to absorb water and a solvent such as an organic solvent to form a swollen polymer gel. In such a case, the embodiments described above each use a dried product of a polymer gel. The term “dried product of a polymer gel” refers to a product resulting from drying a polymer gel for removal of a solvent. For embodiments of the present invention, the dried product of a polymer gel is not necessarily a polymer gel from which the solvent has been removed completely; the dried product may contain a solvent or water as long as the dried product is capable of absorbing moisture in air. The water content of the dried product of a polymer gel is thus not limited to any particular value as long as the dried product is capable of absorbing moisture in air. The water content is preferably not more than 40% by weight, for example. The term “water content” refers to the proportion of moisture in the polymer gel relative to the dry weight of the polymer gel.

A stimuli-responsive polymer refers to a polymer whose property changes reversibly in response to an external stimulus. Embodiments of the present invention use a stimuli-responsive polymer whose affinity with water changes reversibly in response to an external stimulus.

The external stimulus is not limited to any particular one. Examples include heat, light, an electric field, and pH.

The expression “whose affinity with water changes reversibly in response to an external stimulus” describes the affinity of a polymer with water changing reversibly between hydrophilicity and hydrophobicity in response to an external stimulus provided to the polymer.

Among others, a temperature-responsive polymer (that is, a stimuli-responsive polymer whose affinity with water changes reversibly in response to heat) can be used for a humidity controller particularly suitably, as merely changing the temperature of a temperature-responsive polymer with use of a simple heating device allows the temperature-responsive polymer to reversibly absorb moisture (water vapor) in air and release the absorbed moisture.

Specific examples of the temperature-responsive polymer include poly(N-alkyl(meth)acrylamide) such as poly(N-isopropyl(meth)acrylamide), poly (N-normal propyl(meth)acrylamide), poly(N-methyl(meth)acrylamide), poly (N-ethyl(meth)acrylamide), poly(N-normal butyl(meth)acrylamide), poly(N-isobutyl(meth)acrylamide), and poly (N-t-butyl(meth)acrylamide); poly(N-vinylalkylamide) such as poly(N-vinylisopropylamide), poly(N-vinyl normal propylamide), poly (N-vinyl normal butylamide), poly(N-vinylisobutylamide), and poly(N-vinyl-t-butylamide); polyvinylpyrrolidone); poly(2-alkyl-2-oxazoline) such as poly(2-ethyl-2-oxazoline), poly(2-isopropyl-2-oxazoline), and poly(2-normal propyl-2-oxazoline); polyvinyl alkyl ether such as polyvinyl methyl ether and polyvinyl ethyl ether; a copolymer of polyethylene oxide and polypropylene oxide; poly(oxyethylene vinyl ether); a cellulose derivative such as methyl cellulose, ethyl cellulose, hydroxypropyl cellulose, and hydroxypropyl methyl cellulose; and a copolymer of the above polymers.

The temperature-responsive polymer may be a crosslinked product of any of the above polymers. In a case where the temperature-responsive polymer is a crosslinked product, examples of such a crosslinked product include a polymer produced by polymerizing, in the presence of a crosslinking agent, two or more of the following monomers: N-alkyl(meth)acrylamide such as N-isopropyl(meth)acrylamide, N-normal propyl(meth)acrylamide, N-methyl(meth)acrylamide, N-ethyl(meth)acrylamide, N-normal butyl(meth)acrylamide, N-isobutyl(meth)acrylamide, and N-t-butyl(meth)acrylamide; N-vinyl alkylamide such as N-vinyl isopropylamide, N-vinyl normal propylamide, N-vinyl normal butylamide, N-vinyl isobutylamide, and N-vinyl-t-butylamide; vinyl alkyl ether such as vinyl methylether and vinyl ethyl ether; ethylene oxide and propylene oxide; 2-alkyl-2-oxazoline such as 2-ethyl-2-oxazoline, 2-isopropyl-2-oxazoline, and 2-normal propyl-2-oxazoline, and the like.

The above crosslinking agent may be a publicly known crosslinking agent selected as appropriate. Suitable examples of the crosslinking agent include a crosslinking monomer having a polymerizable functional group such as ethylene glycol di(meth)acrylate, propylene glycol di(meth)acrylate, N,N′-methylene bis(meth)acrylamide, tolylene diisocyanate, divinylbenzene, and polyethyleneglycol di(meth)acrylate; glutaraldehyde; polyhydric alcohol; polyamine; polycarboxylic acid; and metal ion such as calcium ions and zinc ions. An embodiment of the present invention may use either only one of the above crosslinking agents or a combination of two or more of the above crosslinking agents.

Examples of a stimuli-responsive polymer whose affinity with water changes reversibly in response to light include (i) a polymer whose hydrophilicity or polarity changes due to light such as an azobenzene derivative and a spiropyran derivative, (ii) a copolymer of the above polymer and at least either a temperature-responsive polymer or a pH-responsive polymer, (iii) a crosslinked product of the light-responsive polymer, and (iv) a crosslinked product of the above copolymer.

Examples of a stimuli-responsive polymer whose affinity with water changes reversibly in response to an electric field include (i) a polymer having a dissociable group such as a carboxyl group, a sulfonic group, a phosphate group, and an amino group, (ii) a polymer containing a complex formed by electrostatic interaction, hydrogen bonding, or the like such as a complex of a carboxyl group-containing polymer and an amino group-containing polymer, and (iii) a crosslinked product of these.

Examples of a stimuli-responsive polymer whose affinity with water changes reversibly in response to pH include (i) a polymer having a dissociable group such as a carboxyl group, a sulfonic group a phosphate group, and an amino group, (ii) a polymer containing a complex formed by electrostatic interaction, hydrogen bonding, or the like, such as a complex of a carboxyl group-containing polymer and an amino group-containing polymer, and (iii) a crosslinked product of these.

The stimuli-responsive polymer may be a derivative of any of the above stimuli-responsive polymers or a copolymer of a stimuli-responsive polymer and another monomer. Such another monomer is not limited to any particular one, and may be any monomer. Suitable examples include a monomer such as (meth)acrylic acid, allylamine, vinyl acetate, (meth)acrylamide, N,N′-dimethyl(meth)acrylamide, 2-hydroxyethyl methacrylate, alkyl(meth)acrylate, maleic acid, vinyl sulfonic acid, vinyl benzenesulfonic acid, acrylamide alkyl sulfonic acid, dimethylaminopropyl(meth)acrylamide, and (meth)acrylonitrile.

The stimuli-responsive polymer may alternatively be a polymer that has formed an interpenetrating polymer network structure or semi-interpenetrating polymer network structure together with another crosslinked or non-crosslinked polymer.

The molecular weight of the stimuli-responsive polymer is also not Limited to any particular value. However, the number-average molecular weight determined by gel permeation chromatography (GPC) is preferably not less than 3000.

The method for producing the stimuli-responsive polymer is also not limited to any particular one, and may be any publicly known method selected as appropriate. The method for producing a porous stimuli-responsive polymer is also not limited to any particular one. A porous stimuli-responsive polymer can be produced by, for example, drying the stimuli-responsive polymer by freeze-drying, vacuum-drying, or the like.

Note that moisture in air (water vapor) being adsorbed and absorbed by a dried product of a polymer gel is scholarly referred to as sorption. However, the main focus of the present invention is to cause, by applying an external stimulus to a dried product, the dried product to release moisture that was absorbed into the dried product. Thus, moisture in air being absorbed into a dried product is herein referred to as “moisture absorption” whereas liquid water being released in the form of a water droplet as a result of application of an external stimulus is herein referred to as “release of water (moisture)”.

### Recap

A water collecting device in accordance with Aspect 1 of the present invention includes: a polymeric moisture-absorbing material containing a stimuli-responsive polymer whose affinity with water changes reversibly in response to an external stimulus; a stimulus applying section for applying an external stimulus so as to decrease the affinity with water of the polymeric moisture-absorbing material; and a vibration section for providing vibration to the polymeric moisture-absorbing material having a decreased affinity with water so as to collect water released from the polymeric moisture-absorbing material.

The above configuration advantageously makes it possible to efficiently collect water released from the polymeric moisture absorbing material.

A water collecting device in accordance with Aspect 2 of the present invention can be configured such that in the above Aspect 1, the vibration section is an ultrasonic vibration section for providing ultrasonic vibration to the polymeric moisture-absorbing material.

The above configuration advantageously makes it possible to efficiently collect water released from the polymeric moisture-absorbing material, since the water easily moves due to a slight difference in character frequency between water and the polymeric moisture-absorbing material.

A water collecting device in accordance with Aspect 3 of the present invention can be configured such that in the above Aspect 1 or 2, the stimuli-responsive polymer is porous.

The above configuration advantageously makes it possible not only to cause more water (moisture) to be absorbed into the polymeric moisture-absorbing material at a high rate but also to efficiently collect water released from the polymeric moisture-absorbing material.

A water collecting device in accordance with Aspect 4 of the present invention can be configured such that in any of the above Aspects 1 to 3, the external stimulus is heat, light, an electric field, or pH.

In the above configuration, a change in heat, light, electric field, or potential of hydrogen is provided, so that the affinity with water of the moisture-absorbing material is changed. This makes it possible to cause moisture absorbed in the moisture-absorbing material to be released from the moisture-absorbing material.

A water collecting method in accordance with Aspect 5 of the present invention includes the steps of: decreasing affinity with water of a polymeric moisture-absorbing material, by applying an external stimulus to the polymeric moisture absorbing material having absorbed moisture in air, the polymeric moisture-absorbing material containing a stimuli-responsive polymer whose affinity with water changes reversibly in response to the external stimulus; and providing vibration to the polymeric moisture-absorbing material having a decreased affinity with water so as to collect water released from the polymeric moisture-absorbing material.

The above configuration advantageously makes it possible to efficiently collect water released from the polymeric moisture absorbing material.

Further, a humidity control device in accordance with an embodiment of the present invention includes the water collecting device.

The above configuration advantageously makes it possible to efficiently control humidity without the need for supercooling or a large heat quantity.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### Industrial Applicability

A water collecting device and a water collecting method in accordance with an embodiment of the present invention each makes it possible to efficiently collect water released from a polymeric moisture-absorbing material, and accordingly makes it possible to efficiently carry out dehumidification without the need for supercooling or a large heat quantity in a case where the water collecting device or the water collecting method is used in a humidity control device.

Therefore, the water collecting device and the water collecting method in accordance with an embodiment the present invention are very useful and can be each suitably used for a humidity control device.

### Reference Signs List

1 moisture absorbing unit
2 polymeric moisture-absorbing material or main polymeric moisture-absorbing material
3 base material or main base material
4 heater or main heater (stimulus applying section)
5 air inlet
6 inlet air filter
7 air outlet
8 air blowing fan
9 water drain tank
10 stepping motor
11 ultrasonic vibrator or main ultrasonic vibrator (vibration section)
12 moist air
13 dry air
14 dripping water
15 secondary polymeric moisture-absorbing material
16 secondary base material
17 secondary heater (stimulus applying section)
18 secondary ultrasonic vibrator (vibration section)
19 secondary moisture absorbing unit
20 adsorbing roller
21 adsorbing material
22 compression roller
23 airflow restriction wall
24 release region
25 moisture absorption region
26 bulk portion of polymeric moisture-absorbing material
27 pores of polymeric moisture-absorbing material
28 motor for compression roller

1. A water collecting device comprising:
a polymeric moisture-absorbing material containing a stimuli-responsive polymer whose affinity with water changes reversibly in response to an external stimulus;
a stimulus applying section for applying an external stimulus so as to decrease the affinity with water of the polymeric moisture-absorbing material; and
a vibration section for providing vibration to the polymeric moisture-absorbing material having a decreased affinity with water.

2. The water collecting device as set forth in claim 1, wherein the vibration section is an ultrasonic vibration section for providing ultrasonic vibration to the polymeric moisture-absorbing material.

3. The water collecting device as set forth in claim 1, wherein the stimuli-responsive polymer is porous.

4. The water collecting device as set forth in claim 1, wherein the external stimulus is heat, light, an electric field, or pH.

5. A water collecting method comprising the steps of:
decreasing affinity with water of a polymeric moisture-absorbing material, by applying an external stimulus to the polymeric moisture absorbing material having absorbed moisture in air, the polymeric moisture-absorbing material containing a stimuli-responsive polymer whose affinity with water changes reversibly in response to the external stimulus; and
providing vibration to the polymeric moisture-absorbing material having a decreased
affinity with water.
